(19) United States
(12) Patent Application Publication
(10) Pub. No.: US 2008/0028989 A1
(43) Pub. Date: Feb. 7, 2008

(54) Process for removing organic contaminants from non-metallic inorganic materials using dielectric heating

(76) Inventor: Scott Kevin Palm, Alpharetta, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/490,197

(22) Filed: Jul. 20, 2006

(51) Int. Cl. C09C 1/00

(52) U.S. Cl. 106/416

(57) ABSTRACT

A method for removing organic-related compounds from a naturally-occurring or synthetic target material containing at least one permeable inorganic material capable of mineral or mineral phase change or dehydration and at least one amorphous carbon, graphite or another organic compound comprising exposing the material to microwave or radio frequency radiation so as to remove at least a portion of the organic ingredients through combustion while limiting the modification of the structure or mineral composition or mineral phase of the inorganic component.

### FIELD OF THE INVENTION

The present invention relates to methods for removing organic contaminants, e.g., carbon, from inorganic materials, e.g., limestone. More particularly, the invention relates to a process of removing carbon in its various forms, including organic carbon and graphite and other organic matter from porous compositions containing organic and inorganic materials through the thermal oxidation of the organic component using dielectric heating, such as microwave energy, while maintaining to a greater extent than is possible with conventional thermal processes, the mineral or mineral phase of the inorganic component of the composition. The invention also relates to the products produced by this method and to applications for these products.

### BACKGROUND OF THE INVENTION

Carbon and organic contaminants are pervasive in the nonmetallic materials industries and these contaminants often significantly reduce the value of nonmetallic materials.

A number of natural mineral or rock deposits are biogenic in origin and contain both inorganic and organic components. For example, diatomaceous earth and limestone deposits contain the inorganic remains in the form of amorphous silica and calcium carbonate, respectively, and also often contain organic remains from the ancient organisms.

In addition to limestone, other carbonate minerals and rocks, also often incorporate organic carbon or graphite into the rock matrix. In some cases, carbon and other organic contaminants have been introduced by geologic forces subsequent to the formation of the rock. In addition, mixtures of organic and inorganic materials are often created in manufacturing processes, such as in the filtration of liquids.

Carbon, other organic materials and inorganic materials are also present in certain agricultural products that are processed in large volumes worldwide. For example, rice hulls, a waste product from the milling of rice grains, contain both amorphous silica and organic components. Rice hulls are sometimes used as fuel in electricity generation, and the combustion product can contain a high percentage of amorphous silica and some carbon. These mixtures are sometimes referred to as spent cake.

Carbon and inorganic compounds are frequently intimately mixed with and sometimes physically combined with inorganic materials in industrial processing. For example, diatomite, perlite and rice hull ash filter aids are commonly used as filter aids during the separation of organic turbidity from organic and inorganic liquids. Acid activated clays and silica gel are often used as adsorbents in similar liquids. The waste products from these processes contain intimate mixtures of the inorganic processing media, organic turbidity and the liquid.

The presence of carbon, graphite or other organic compounds in inorganic materials can reduce the functionality of the inorganic materials in a number of applications. Various thermal processes exist whereby carbon can be removed from inorganic materials, but such processes are non-selective and can result in changes to the properties of the inorganic materials. Such changes are often not desirable.

Silicate minerals and rocks and carbonate minerals and rocks can undergo either mineralogical or mineral/chemical phase changes when heated to elevated temperatures.

Silicate minerals and rocks include inorganic materials that incorporate some silicon and oxygen. Common silicate minerals include amorphous silicas, cristobalite, quartz, trydimite, several types of feldspar (microcline, orthoclase, albite, sanidine, anorthite and others), clays (kaolinite, halloysite, illite, montmorillonite, hectorite and others), vermiculite, micas (muscovite, biotite, phlogopite, sericite and others), talc, pyrophyllite, zeolites (heulandite, clinoptilolite, chabazite, erionite and others), nepheline, a number of calcium silicate minerals (i.e., wollastonite, tobermorite, palygorskite and others) and numerous others.

Inorganic materials formed through biogenic, sedimentary or metamorphic processes are more likely to contain carbon or organic contaminants than are those formed through igneous processes. Diatomaceous earth, rice hull ash, sponge spicules, bamboo and some other biogenic materials can contain organic and inorganic amorphous silica components. Hydrated amorphous silica can convert to a hydrated amorphous form of silicon dioxide, opal-c, and forms of amorphous silica can convert to crystalline forms, such as cristobalite, trydimite or quartz.

Kaolin clay, which is the chief mineral component of commercial kaolin products and a significant component of ball clays and common clays, is a crystalline mineral with a platy crystal structure. Many natural clay raw materials contain mixtures of kaolin, some inorganic impurities, such as quartz, feldspar and mica, and organic materials. Ball clay, in particular, is very commonly associated with organics. Kaolin clays can also be intimately associated with carbon and organic contaminants. In Inner Mongolia, China, very extensive deposits of otherwise very high quality kaolin clays are mixed with coal and other carbon-rich contaminants. When heated to high temperatures, kaolin clay is converted to metakaolin and then to calcined kaolin, a composition that includes silicon spinel, alumina and silicon-alumina spinel, and at even higher temperatures, to mullite and cristobalite.

Perlite, a silicate rock, is found in a massive, hydrated state naturally, but converts to partially dehydrated, very light density intricate forms upon rapid heating. Perlite is believed to originate as obsidian, a volcanic glass with a chemical composition similar to rhyolite. Perlite is formed by the partial weathering of obsidian, a lengthy process in which some water becomes chemically combined with the glass. Most commercial perlites contain about 2-5% combined water by weight.

Carbon dioxide is liberated from carbonate minerals, which convert to lime, dolomitic lime and magnesia. Calcium and magnesium are very commonly found in the form of the carbonate crystalline minerals, calcite and aragonite (for calcium), magnesite (for magnesium) and dolomite (for calcium and magnesium). Common calcium carbonate rocks include limestone, travertine, caliche, onyx and marble. Carbonate rocks often include mixtures of carbonate minerals, some inorganic impurities and organic remnants, either in the form of carbon or graphite.

Nutraceuticals and other mineral supplements may contain calcite, aragonite, dolomite and magnesite or magnesia (magnesite in which the carbon dioxide has been liberated). “Coral calcium,” a commercial term that refers to calcium carbonate in the form of coral, shells or partially metamorphosized coral or shells, has been a popular ingredient in mineral supplements and nutraceuticals in recent years.

Some other carbonate minerals include the carbonates of manganese (rhodochrosite), iron (siderite), strontium (strontianite), and barium (witherite).

Commercial processes used to process inorganic minerals today often rely upon conventional drying, calcining and sintering processes, which most often involve combustion of a fossil fuel. In conventional processes, the heating of the materials occurs through conduction and convection, from the outside of the particle and proceeds to the inside, and the temperatures reached by organic and inorganic components are nearly identical.

Large volumes of diatomaceous earth, rice hulls, limestone and clays are processed thermally in order to produce products of commercial value. Amorphous diatomaceous earth is normally heated in rotary kilns, either with or without fluxing additives, to its softening point. When softened, the material can agglomerate and form larger particles, a property which is useful in producing a range of filter aids and fillers of controlled properties. This means of processing also tends to oxidize organic contaminants and to convert some of the amorphous silica to cristobalite.

Like limestone and marble, natural amorphous silicas are generally biogenic in origin and often retain organic carbon. In many of the commercial diatomaceous earth deposits, the amount of carbon has been reduced over time by natural processes, but most deposits contain some carbon that is removed during thermal processing, which, in many cases, converts some of the amorphous silica to crystalline forms, such as cristobalite and quartz. These crystalline forms of silicon dioxide have been shown, when inhaled for extended periods, to be a cause of silicosis and lung cancer. The organic contaminants in diatomaceous earth deposits can make such materials undesirable for use in the processing of food and beverage products where the presence of the organic component can lead to undesirable taste and odor contributions to the food or beverage.

Markets for natural (amorphous uncalcined) diatomite exist, but many of these markets cannot be served cost effectively from deposits containing high levels of organic contaminants, as a good, low cost process for removing the organic contaminants while preventing the formation of cristobalite and particle agglomeration does not exist. As a result, the markets for natural diatomite are served today either from a limited number of deposits which have been naturally weathered and which have a low organic content or from an intensive beneficiation process.

Due to the cost of the purchase, transport and disposal of filter aids and adsorbents, considerable effort has been made to develop processes to recycle spent cake containing these materials. However, these efforts face substantial technical and commercial barriers. In addition to the requirement for scale economies, the conventional approaches rely on thermal processes which tend to modify the mineralogy and particle size distribution of the filter aids contained in the spent cake. In addition to the technical challenges associated with the oxidation of organic debris associated with spent filter cake, while attempting to prevent the agglomeration of the particles, there are cost and scale considerations. Conventional diatomite processing facilities are capital intensive and are generally not practical on a scale that would be useful in individual consumer plant sites.

Diatomite, in the form of natural (uncalcined) material, calcined diatomite or flux calcined diatomite is sometimes used as a raw material in the manufacture of calcium silicate and magnesium silicate products. In these processes, the silicate product is formed through the reaction of diatomite with high calcium or dolomitic lime or magnesia. Common mineral phases for these silicate products include, but are not limited to, tobermorite and palygorsite. When natural (uncalcined) diatomite is used as a raw material, some or all of the organic contaminants contained in the diatomite survive the manufacturing process and are found in the final product. These remnant organics reduce the brightness of the silicate product and can limit their usefulness in functional filler and pharmaceutical applications.

For example, calcium silicate and related products can be used in the adsorption of lipids contained in blood plasma and other biologic fluids and more general applications in lipid removal from non-biologic fluids exist for these products. Some of the products are derived from diatomaceous earth, and may contain remnants of the organic-related substances found in diatomaceous earth. Such remnant organic compounds may not be appropriate for use in products used in contact with parenteral blood and other biopharmaceutical products.

Rice hulls, a waste product from the production of rice grain, are produced in enormous quantities worldwide and significant efforts have been undertaken to identify and develop applications for these materials. Large volumes of rice hulls are produced as a by-product of rice farming and milling and the hulls are sometimes used as fuel in electricity generating facilities. Historically, these materials were processed at high temperatures and the resulting silica content of the ash converted to a high percentage of cristobalite. The rice hull ash products produced by one commercial producer of rice hull ash contain less than 1% crystalline silica and 2-8% carbon. The carbon content and color limit the functionality of these materials in a number of applications, including as filter aids, functional fillers and as a chemical ingredient in the production of synthetic silicas and silicates.

One of the interesting aspects of rice hull ash is that it can contain low levels of extractable metal impurities, a valuable attribute in a number of filtration markets, where purity is important. Some examples of these markets include the pharmaceutical, specialty beverage and specialty chemical industries. However, the carbon content, among other properties, has limited the use of rice hull ash in these applications. The technology required to bring diatomaceous earth to these levels of purity is known in the art, as are the test methods related to the determination of beer soluble aluminum and beer soluble iron content.

Rice hulls may also have a combination of properties, including silica chemistry, structure, purity and appropriate particle size, which, when found in diatomaceous earth products, have been demonstrated to be of value in the leukoreduction of whole blood, blood plasma, platelet concentrate and red blood cell concentrate (Palm 2000). In leukoreduction, leukocytes (white blood cells) are separated from the desired blood component, such as platelets, red blood cells or whole blood, in order to reduce the risk of an immune response from the patients who are to receive the blood products. With appropriate screening, air classification or other classification of rice hull ash, porous silica materials can be produced. However, when these materials are produced from rice hull ash prepared using conventional combustion processes, they may contain levels of active carbon unacceptable for contact with blood products or other parenteral biopharmaceutical products.

Conventionally-processed rice hull ash contains some crystalline silica and crystalline carbon, in the form of graphite. Products free of crystalline silica containing 0-3% amorphous carbon and no graphite can be produced through the pyrolysis of rice hulls (not rice hull ash) in a tube furnace within a temperature range of 500-800 C. In addition to the process, rice hulls free of crystalline silica and graphite (but containing 0-3% amorphous carbon) with a particle size substantially in the 1-100 micron size range can be produced. It has been reported that conventional rice hull ash contains graphite, which is difficult to remove.

Other work in the area of rice hull ash has concerned wet processing of the ash, either prior to combustion or in place of combustion, the production of various products from the ash, including activated carbon and synthetic silicas and applications for ash in a number of areas, including construction-related applications such as cement and concrete.

As in the case of marble, limestone and diatomaceous earth, ball clays can contain organic matter that is benign in many of the existing applications for these materials. For example, most of the organics contained in commercial ball clays oxidize, and the clays fire to a white color, when they are used as ingredients in conventional oxide ceramics. However, these same organic components can limit the use of ball clays in other, more color sensitive applications, such as textile glass fibers and many filler and extender applications.

Large reserves of relatively chemically pure limestones exist in the world. However, nearly all of the deposits contain organic carbon. Mechanical and chemical processes for the removal of the carbon exist, but are associated with high capital and operating costs. Therefore, in a number of filler and extender applications where high whiteness and brightness are required, limestone raw materials are generally not competitive with white marble raw materials.

Many naturally-occurring inorganic rocks and minerals contain some solid organic impurities. Minerals and rocks of biogenic evolution, such as limestone and diatomaceous earth, often retain some solid organic remains of the life forms from which they are derived. It is also common for some organic material from other plant or animal sources or from the migration of petroleum or related compounds to be found in rock and mineral deposits. Shale, slate, limestone, clay and numerous other rocks commonly include some solid or mixtures of solid and liquid organics. Shale and its metamorphic counterpart, slate, can incorporate clays and micas, two types of silicate minerals, as well as other silicate minerals, organics and, in some cases, carbonate minerals.

These organics can, over time, be modified or eliminated through natural processes, leading to purer, brighter inorganic materials with generally greater commercial value. For example, limestone, when subjected to heat and/or pressure through regional metamorphism or intrusive igneous processes, can form a more fully crystalline material, marble. During the process of forming marble, the organic component of limestone often migrates away from the heat or pressure source and is also sometimes transformed into graphite, a crystalline form of carbon.

The graphite that remains in crystalline marble can have a desirable aesthetic effect in marble cut and polished and used in dimension stone (tiles, counter tops, building façade) applications, and the organics remaining in limestones can be benign in the many applications in which limestones are used today (for example, construction aggregates or in lime manufacturing).

However, carbon and graphite content have a deleterious impact on the use of ground crystalline marble and limestones in many filler and extender applications. As a result, most limestones and marble materials that contain organic carbon or related minerals, such as graphite, are not used in filler applications requiring very high whiteness and brightness.

White marble deposits suitable for use in the most demanding filler applications, such as paper coating, paper filling and some paint, plastics and sealants applications, are not common. In the United States, for example, the higher quality deposits are found only in Vermont, Massachusetts, Georgia, Alabama, and Washington. It has been reported that white limestone deposits suitable for these applications are even more unusual. Similar geographic limitations exist worldwide. Chemically pure, lower brightness (due to organics content) limestone deposits are more common.

The organic carbon contained in limestone can be removed, and is removed in large quantities, through thermal processing in the production of lime (calcium oxide). In this process, the carbon dioxide is liberated from the limestone, the organic content of the raw material is largely oxidized and lime is produced.

Lime can be converted into a very bright white filler calcium carbonate product through the precipitated calcium carbonate process. Although precipitated calcium carbonate is generally more expensive than ground marble, it often has transportation cost and technical applications advantages over ground marble, and the use of precipitated calcium carbonate has become widespread, particularly in paper filler applications.

Precipitated calcium carbonate and some selected natural limestones and marbles are also used in pharmaceutical and supplement applications. Specifications in these applications, in terms of lead, arsenic and heavy metal content, rule out the use of many natural ground materials. Another limiting factor is the volatile organic content, particularly for most limestones, due to their organic impurities.

Limestones, lime, dolomite and dolomitic lime are sometimes used in applications in which the sulfur content of the material affects performance. For example, in the iron and steel industry, the sulfur content of the raw materials used can sometimes affect the sulfur content of the iron and steel in various stages of production. While sulfur can be tolerated in flue gas desulfurization processes, the capacity of the media can be reduced if it contains sulfur. Sulfur is often associated with organic carbon and materials containing lower levels of organic carbon generally also contain lower levels of sulfur.

Travertine, limestone, marble and onyx are used in large quantities in dimension stone applications. In these applications, the materials are cut into blocks in the quarry and are then cut to finer sizes, generally 2 cm. or 3 cm. thick slabs or thinner tiles and are sometimes polished. These products often contain carbon contaminants which can either add to or detract from both the aesthetic appeal and the value of the materials. For example, most commercial travertine deposits contain travertine that is tan, beige or brown. White or nearly white travertine is less common and can command a higher unit price than the conventional tan, beige and brown travertines.

Caliche, a product of the dissolution and precipitation of carbonate rocks through natural weather processes, occurs naturally in many locations, especially those with arid climates. Generally, caliche occurs as a thin layer of organically-contaminated calcium carbonate. Caliche can also sometimes be contaminated with locally-occurring rocks. In some cases, caliche occurs in beds several feet in thickness with little host rock contamination. However, organic contaminants generally still occur. Opportunities may exist to use caliche as a filler raw material when only organic contaminants are present if such contaminants can be removed.

Ball clay is also used in very large quantities worldwide and is thermally processed in operations that oxidize its organic content. Generally, ball clay is used due to its impact on the green strength of oxide ceramic intermediaries. As a component of a ceramic composition, the ball clays are fired and their organic contents removed as the clays are incorporated into the ceramic material.

Opportunities to use low organic or organic-free ball clays may exist in applications which are either not served today or which are served by other raw materials. For example filler applications for these fine clays, if free from organics, might exist. In addition, the organic contaminants of ball clay render them less desirable than materials sold commercially as air floated kaolins, which have a lower organic content, as chemical ingredients, for example as raw materials in the manufacture of textile glass fibers.

Enormous quantities of otherwise very high quality coal and organic contaminated kaolin clays occur. In some cases, for example, in Inner Mongolia in China, these clays are used in applications where the clay is fired to a high temperature before or during use, such as in the production of calcined clay fillers or in the production of ceramic materials. However, the use of these materials in traditional hydrous (uncalcined) kaolin applications, such as a paper filler or in some specialized ceramic applications, has generally not occurred.

### BACKGROUND OF THE ART

Methods to remove organic contaminants from inorganic materials exist but often have undesirable side effects. For example, thermal methods in which the organics are oxidized at high temperature also subject the inorganic materials to the same elevated temperature which can result in unattractive modifications to the properties of the inorganic. Removing carbon from limestone or organic contaminants from diatomaceous earth ores through thermal means can result in the formation of lime and cristobalite, respectively. Lime cannot be used interchangeably with limestone in most applications, and many users of diatomaceous earth filter aids would like to avoid using products containing cristobalite due to health concerns. In addition to the health-related concerns associated with crystalline silica, the formation of cristobalite at elevated temperatures, can lead to undesirable agglomeration of the particles, particularly when very fine permeability filter aids or functional fillers are required or when, in recycling filter aids, there is a desire to obtain, as closely as possible, the original properties of the filter aid.

In addition, modifications to the mineralogy of the diatomite filter aids and other filtration media and processing aids, such as adsorbents, generally affects other properties of value, such as the surface chemistry and surface area. For example, in the case of diatomite filter aids, the extractable chemistry of diatomite generally changes as the mineralogy of the material changes. The solubility of iron and other impurities can increase and the surface area of the material will decrease as the amorphous silica contained in the diatomite is converted to cristobalite.

Microwave energy is commonly indirectly employed in the removal of carbon and related compounds from inorganic materials in laboratory ashing furnaces. In these microwave ovens, which are frequently specifically designed for ashing purposes, most of the microwave energy is absorbed by materials other than the components of the target material and the heat is transferred from these materials through conventional means to the target material and its components. Silicon carbide, which possesses high microwave absorption and heats rapidly when exposed to microwave energy, is often employed in ashing operations, in crucible or other forms. As a result, microwave ashing techniques in use are not designed to preserve the mineral composition and mineralogy of the target materials.

Grinding, liberation and some wet chemical treatments, such as bleaching, can remove some organic contaminants, but these processes can have substantial water and chemical requirements and substantial drying costs.

Radio frequency and microwave energy devices, which cover the wavelengths of 1-300 MHz and 300-30,000 MHz, respectively, have been investigated for their potential usefulness in materials processing and in separation processes. Radio frequency and microwave heating, commonly collectively referred to as dielectric heating, have been adopted in a number of commercial-scale food and ceramic processes in recent years and large continuous dielectric heating devices are now available with a range of wavelength and power capabilities. Available equipment is now capable of handling the large quantities of material commonly processed in the non-metallic mineral and related materials industries.

Dielectric heating differs from conventional heating in that most of the heat is created when the electromagnetic radiation is absorbed. Because, like other forms of electromagnetic radiation, such as visible light, the dielectric energy possesses the properties of both a wave and a particle, patterns of high and low energy, consistent with the wavelength of the energy, can develop within a dielectric furnace. For this reason, most home microwave ovens contain mechanisms for rotating food products within the oven, so that they can move between high and low energy areas and cook evenly. For industrial processes, similar approaches can be used, but it is also common to employ mechanical mode stirrers, which disperse the energy in order to avoid the formation of hot and cold spots in the furnace.

As mentioned above, dielectric heating can employ microwave and radio frequency radiation that cover a broad range of wavelengths and the interaction of certain wavelengths with certain materials and the particle sizes of certain materials may vary. In general, as the wavelength increases, the penetration depth of the energy into a solid particle increases, but the energy decreases. As a result, there can be performance differences in the various potential applications of dielectric furnaces between dielectric energies of differing wavelengths. For materials that are relatively transparent to dielectric energy, such as the inorganic materials of interest to the present invention, the penetration depth is much greater than for materials that are strong absorbers of dielectric energy.

The heating characteristics of selected minerals and compounds have been reported in the art. They concluded that common “gangue” minerals, such as, but not limited to, silicate minerals and rocks (silicon dioxide, feldspar, almandine, allanite, anorthite, gadolinite, muscovite, titanite, zircon and others) and carbonate minerals and rocks (such as aragonite, calcite, dolomite and siderite) are relatively transparent to dielectric energy and are difficult to heat in a dielectric furnace. In contrast, amorphous carbon and graphite are strong absorbers of dielectric energy and heat rapidly when exposed to it.

The effects of power level on the microwave heating of selected chemicals and minerals have been reviewed. They mention that most metallic ore minerals heat rapidly when exposed to microwave radiation, whereas many common host rocks do not. They found that a number of minerals respond to exposure to higher microwave power by heating more rapidly, but found that silicon dioxide and calcium carbonate are not responsive to microwave exposure at elevated power levels (2 kW vs. 500 W).

Their findings with regard to the impact of power level on the heating rate of various materials are of potential relevance in the scale up of processes from low power to higher powered units. They found that the relationship is not necessarily linear and that as power is increased, heating rates can increase very significantly.

Another research study teaches that asphaltic concrete can be recycled through a process that includes crushing, the addition of sulfur or other additives, heating in a microwave oven and mixing.

Another research study teaches that certain toxic organic contaminants can be separated from solid materials by heating the materials to between 200 degrees F. and 750 degrees F. until the toxic contaminant is vaporized. Such vapors can then be conveyed to an electrochemical cell where they can be oxidized.

Another research study teaches methods to measure the carbon content and reduce the carbon content of vitreous fly ash consisting of fused alumina, silica, iron oxides, alkaline earths and other species originally contained in coal through exposure to microwave energy. Another research study teaches a number of improvements related to the reduction of fly ash carbon content through use of microwave energy, including the use of both pre-heat and combustion chambers, tumble mixing of the ash, and injection of air and oxygen into the tumbling ash.

The use of microwave or radio frequency radiation in oil recovery has been an active field of research. It has been taught in the art that microwave or radio frequency radiation can assist in the separation of organic liquids from solids either by evaporating the liquids for later recovery through precipitation or by reducing the viscosity of the liquids and improving their flow rates through porous materials. This field has covered recovery of petroleum liquids from a number of rock types, and both in-situ processes and industrial treatments of mined material. Several reported studies teach various aspects related to the use of microwave or radio frequency radiation in petroleum recovery.

Methods and apparatus for the elimination of unwanted impurities and inclusions from non-conductive base materials through the application of high powered variable frequency, radio frequency energies in selective or rarefied atmospheres, resulting in the vaporization of the unwanted impurities are known in the art.

One group has tested microwaves in the processing of lime muds produced during the papermaking process and teaches that beneficiated lime mud consisting mainly of calcium carbonate can be converted to lime when exposed to radio frequency or microwave radiation. A 6 kW 2450 MHz device was employed in this group's work.

The use of microwave or radio frequency radiation in cleaning or sterilizing ceramic filter elements, for both air and liquid filtration and in the treatment of sludge and wastewater has been disclosed.

One researcher has tested microwave radiation in the separation of inorganic sorbents and organic liquids, whereby by treating sorbents intimately mixed with organic liquids through dielectric heating, the organic liquids can be evaporated and recovered through precipitation.

Another researcher teaches that samples introduced into a chromatography device in a solvent can be modified by evaporating the solvent through exposure to microwave energy prior to carrying out chromatography.

A need exists in a number of industries for a selective method of heating in which carbon and organic contaminants can be removed from inorganic materials without modifying the inorganic materials. Dielectric heating is capable of such selective heating and dielectric heating devices capable of processing large volumes of material are becoming increasingly available. The present invention provides for the application of microwave and radio frequency radiation in the removal of carbon from inorganic materials while maintaining the desirable properties of such inorganic materials.

### SUMMARY OF THE INVENTION

The present invention concerns the use of microwave or radio frequency energy to remove carbon, graphite and other organic compounds from inorganic materials while limiting undesirable mineral, mineral phase or physical changes to the inorganic materials, thereby allowing many natural raw materials and industrial waste products to be used in higher value applications.

For the purposes of the present disclosure, the following terms shall have their associated meaning. “Organic-related compounds” is intended to include, without limitation, carbon, graphite and other organic or organically-derived compounds. “Mineral change” refers to the conversion of some or all of a carbonate mineral to an oxide equivalent (i.e., calcium carbonate to calcium oxide) through the liberation of carbon dioxide. “Mineral phase change” refers to the conversion of either an amorphous mineral to a crystalline mineral (i.e., Hydrated amorphous silica or opal-c to cristobalite) or the conversion of one crystalline mineral phase to another crystalline mineral or phase (i.e., quartz to cristobalite or kaolinite to metakaolin, calcined kaolin, mullite or cristobalite). The dehydration of an amorphous mineral phase (i.e., amorphous hydrated silica to opal-c) shall be considered dehydration for the purposes of this invention.

Generally described, the present invention provides in a first exemplary embodiment a method for the removal of carbon-related compounds from compositions including one or more inorganic materials and the carbon-related compounds by exposing the composition to microwave or radio frequency energy and thermally oxidizing the carbon-related compounds, while substantially preserving the mineralogical or mineral phase state of the inorganic component.

Also provided are products produced from these methods, including whiter, brighter limestone and marble products; whiter, brighter amorphous silica products; higher performance recycled diatomaceous earth or perlite products; and numerous other products in which conventional materials beneficiation/purification processes are limited in their effectiveness to cost effectively remove Carbon & Related Compounds from mixtures with nonmetallic inorganic compounds.

Other features and advantages of the present invention will become apparent upon reading the following detailed description of embodiments of the invention, when taken in conjunction with the appended claims.

### BRIEF DESCRIPTION OF THE DRAWINGS

The patent or application file contains at least one photograph executed in color. Copies of this patent or patent application publication with color photographs will be provided by the Office upon request and payment of the necessary fee.

The invention is illustrated in the drawings in which like reference characters designate the same or similar parts throughout the figures of which:

FIG. 1 is a photograph of the material produced in Example 1.

FIG. 2 is a photograph of the material produced in Example 3.

FIG. 3 is a photograph of the material in Example 4 before processing.

FIG. 4 is a photograph of the material in Example 4 after processing.

FIG. 5 is a photograph of the material produced in Example 5.

FIG. 6 is a photograph of the material produced in Example 5.

### DETAILED DESCRIPTION OF THE INVENTION

Provided is a process in which compositions including carbon and related compounds and inorganic components capable of mineral or mineral phase changes are placed in a chamber composed of microwave reflecting materials and are then exposed to as much as about 105,774 Kilowatt hours (“KWh”) per metric ton and in which the mineralogical and/or mineral phase of the inorganic component are either unchanged or are limited to dehydration.

Provided is a process in which compositions including carbon and related compounds and inorganic components capable of mineral or mineral phase changes are placed in a chamber composed of microwave reflecting materials and are then exposed to as much as about 105,774 Kilowatt hours (“KWh”) per metric ton and in which the mineralogical and/or mineral phase of the inorganic component are either unchanged or are limited to dehydration.

Provided is a process in which compositions including carbon and related compounds and inorganic components capable of mineral or mineral phase changes are placed in a chamber composed of microwave reflecting materials and are then exposed to as much as about 105,774 Kilowatt hours (“KWh”) per metric ton and in which the mineralogical and/or mineral phase of the inorganic component are either unchanged or are limited to dehydration.

Provided is a process in which compositions including carbon and related compounds and inorganic components capable of mineral or mineral phase changes are placed in a chamber composed of microwave reflecting materials and are then exposed to as much as about 105,774 Kilowatt hours (“KWh”) per metric ton and in which the mineralogical and/or mineral phase of the inorganic component are either unchanged or are limited to dehydration.

In preferred embodiments, the target materials are exposed to less cumulative energy while still retaining the original mineral structure, except for some dehydration. For example, in one preferred embodiment, the target material is exposed to less than 50,000 KWh of dielectric energy per metric ton. In another preferred embodiment, the target material is exposed to less than 10,000 KWh of dielectric energy per metric ton. In another preferred embodiment, the target material is exposed to less than 5000 KWh of dielectric energy per metric ton. In another preferred embodiment, the target material is exposed to less than 1000 KWh of dielectric energy per metric ton. In another preferred embodiment, the target material is exposed to less than 387 KWh or dielectric energy per metric ton.

In further preferred embodiments, the target materials are exposed to less than 13,000 KW of dielectric power per metric ton while still retaining their mineralogical structure, except for some dehydration. In a preferred embodiment, the target material is exposed to less than 5000 KW of dielectric power. In another preferred embodiment, the target material is exposed to less than 2321 KW of dielectric power.

In further preferred embodiments, the target materials are exposed to less energy and/or power while still substantially retaining their mineralogical structure.

In further embodiments, the target materials contain one or more silicate minerals. In further embodiments, the target materials contain: diatomaceous earth, calcined diatomaceous earth, flux calcined diatomaceous earth or spent cake containing some form of diatomaceous earth; or rice hulls or rice hull ash; orbiogenic silica, precipitated silica, fumed silica, silica gel or colloidal silica; or kaolin clay, ball clay, montmorillonite clay, halloysite, dickite, hectorite or other clay minerals; or a calcium silicate mineral, such as wollastonite, tobermorite, palygorskite or other calcium silicate minerals; or talc, pyrophyllite, muscovite mica, biotite mica, sericite mica or phlogopite mica; or, a zeolite. And in each of these cases, the conversion of the silicate minerals mentioned above is limited to the dehydration of any hydrated minerals present.

In preferred embodiments, the conversion of the silicate minerals mentioned above to other forms of crystalline minerals is limited to less than 95% of the target material and, more preferably, to less than 50% of the target material and, still more preferably, to less than 25%; less than 10%; less than 5%; less than 1% and less than 0.1% of the target material, except for dehydration of hydrated minerals.

In a preferred embodiment, the target materials contain carbonate minerals. In further embodiments, the target materials contain:

calcite; or aragonite; or dolomite; or magnesite; rhodochrosite, siderite, strontianite or witherite; carbonate rocks such as limestone, dolomite, dolomitic limestone, magnesite, marble or dolomitic marble; or carbonate rocks such as travertine, onyx or caliche; or, calcite or aragonite derived from coral, shells or partially metamorphosized coral or shells.

In further preferred embodiments, less than 95% of the target material is converted to a mineral free of carbon dioxide and in further preferred embodiments less than 50%; 25%; 10%; 5%; 1% or 0.1% of the target material is converted to a mineral free of carbon dioxide.

Further embodiments of the invention include the products produced by the methods described as well as the applications for which these materials are suited, including filtration, adsorption, selective separation, functional filler, glass and ceramic, flame retardant, dimension stone (tile, counter top, slab, building faces, etc.), catalyst support, and catalysts.

One skilled in the art can readily appreciate that many modifications and permutations of the present invention are possible, and may include, but are not limited to:
The rotation or other movement of the target materials within the furnace in order to provide more even distribution of dielectric energy to the target material;
The use of a mechanical mode stirrer in order to provide more even distribution of dielectric energy to the target material;
The optimization of the process, in terms of energy requirements and penetration through the selection of appropriate target material particle size and wavelength of the dielectric energy. In some cases, this may benefit from the use of more than one wavelength at different points in the process and the use of a multiple mode microwave cavity;
The use of agglomerated or pelletized target materials in order to obtain closely-sized target material granules of a particularly attractive particle diameter;
The use of conventional heating either prior to or following the application of dielectric energy. Such application may have benefit in reducing the temperature gradient between the different substances contained in the target material or in reducing the temperature gradient between the inside of the particles of the target material and the exterior surface of the target material;
The application of other beneficiation technologies, such as acid leaching, oxidative bleaching, reductive bleaching or other common approaches which may be beneficially applied to reduce the carbon content of the exterior surface of a particle of the target material. This may be especially beneficial when granular or larger samples of the target material are beneficiated using dielectric energy and a greater amount of carbon is removed from the inside of the particle than from the external surface and the areas adjacent to the external surface;
The use of other technologies commonly employed to brighten or otherwise beneficiate industrial mineral products, including selective flocculation, magnetic separation, etc.;
The application, either before or after the application of dielectric energy, of various technologies used to classify particulate and granular materials into different particle size distributions, such as screening, air classification, hydrocycloning, centrifugation, Humphrey spirals, shaking tables, and other wet and dry particle size classification technologies;
The beneficiated inorganic products produced by processing the various target materials through the processes of this invention; and,
Modifications to the surface chemistry of the inorganic products of the present invention through the application of silanes, stearic acids, surfactants, silicones, polymers and other common surface modification substances.

An advantage of the method of the present invention is the removal of organic compounds but with a reduced likelihood of certain changes in the crystalline structure of the inorganic material occurring during the heating process. Or, stated differently, the method of the present invention better preserves the pre-processing mineralogy and crystalline structure of the inorganic material processed. Example 1 below demonstrates that after processing essentially no lime was detected. Lime is a product of a mineral change to the principal inorganic mineral constituent of limestone, calcite, to lime (calcium oxide) through the liberation of carbon dioxide.

### EXAMPLES

The invention will be further described in connection with the following examples, which are set forth for purposes of illustration only. Parts and percentages appearing in such examples are by weight unless otherwise stipulated.

### Example 1

### Removal of Organics from Carbonate Rock

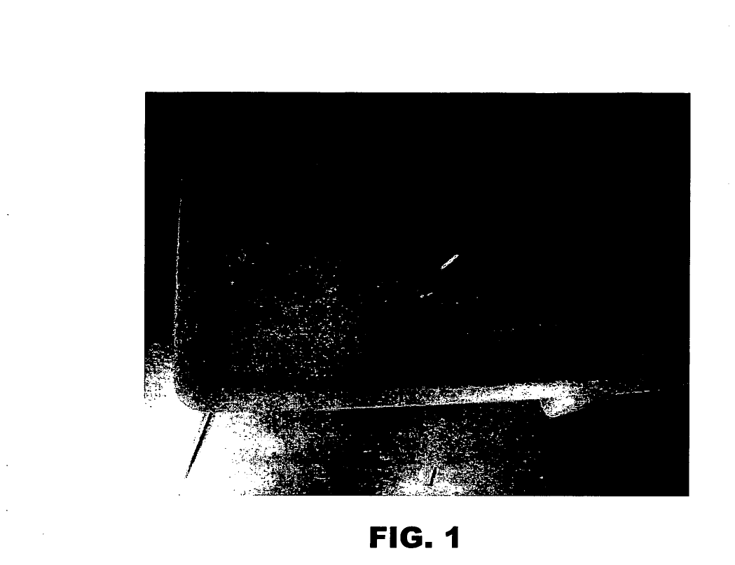

Four chips, each several inches long, of very black calcitic limestone from San Luis Potosi State, Mexico were exposed, in a 5 Kilowatt 2,450 MHz microwave oven manufactured by Thermex Thermetron, Louisville, Ky., to 4.5 kW of 2,450 MHz microwave energy for five minutes. At the conclusion of the exposure, most of the volume of the chips was glowing red hot, and an odor of sulfur was detected, indicating that combustion of the organic component of the material was taking place (See FIG. 1). When exposure to microwave energy was stopped, the material cooled and combustion ceased. Upon cooling, the color of the material had changed to a mixture of gray and white. The interior of the samples were white and the exterior was gray.

These samples were analyzed by x-ray diffraction and no lime was detected. In other words, none of the calcium carbonate contained in the sample underwent mineral conversion to calcium oxide (lime).

### Example 2

### Removal of Organics from Carbonate Rocks

A single chip of very black calcitic limestone from San Luis Potosi State Mexico, weighing 182 grams, was preheated in a convection oven at a temperature of 470 F for 10 minutes and was then placed in a 1.3 kW variable powered, 2,450 MHz microwave oven capable of 10 different power settings (10=highest). The oven, Panasonic model number NN-T664SF, was initially set at power level 5 for 5 minutes, and the power level was then set at level 8. At this power level, the material began to glow red hot and after 30 seconds, exploded.

9 grams of fine fragments were recovered and disposed of and the remaining material, now consisting of 4 chips, was heated at power level 5 for 2.5 minutes, at power level 4 for 1 minute 20 seconds and at power level 6 for 20 minutes. The power level was raised to level 7 for 8 minutes and 41 seconds, and then the rocks were removed. The lower power levels were used initially in order to avoid additional decrepitation of the material, and the levels were raised in order to maintain the material in a red hot state to assure that combustion of the organics continued as the organic content declined. During most of this time, the material glowed red hot and a sulfurous odor was present, indicating combustion of the organic component.

The limestone was exposed to a maximum microwave energy level of 5714 Kilowatts per metric ton and to cumulative microwave energy of 2831 Kilowatt hours per metric ton.

The chips were allowed to cool. As in the case of Example 1, the interior of the chips had turned white, which graded to a light gray at the exterior of the chips. The weight of the chips was determined to be 170 grams, indicating that 3 grams (182 initial weight less the 9 grams removed less the final weight) had been lost due to the combustion of the organics.

The material was submitted to x-ray diffraction and no lime was detected. In other words, none of the calcium carbonate in the sample underwent mineral conversion to calcium oxide (lime).

### Example 3

### Removal of Organics from a Carbonate Rock

A sample of gray recrystallized limestone from San Luis Potosi State, Mexico containing one polished surface, was broken into several pieces. The largest piece was retained as a control while four smaller pieces were subjected to microwave energy in a variable power 1.3 kW, 2450 MHz oven (Panasonic NN-T664SF) with 10 power settings (10=highest). The oven was set at power level 6, and the material was exposed for 10 minutes. A sulfurous odor was noted after heating for two minutes and thirty seconds, indicating that combustion of the organic component had commenced.

The limestone was exposed to a maximum microwave energy level of 2321 Kilowatts per metric ton and to a cumulative energy of 387 Kilowatt hours per metric ton.

Upon cooling, the material was inspected and compared to the control. The polished surface, while still a light gray, was much lighter in color than the control. The unpolished edges of the samples were also considerably lighter in color than the control and, in places, had the appearance of bright, white marble.

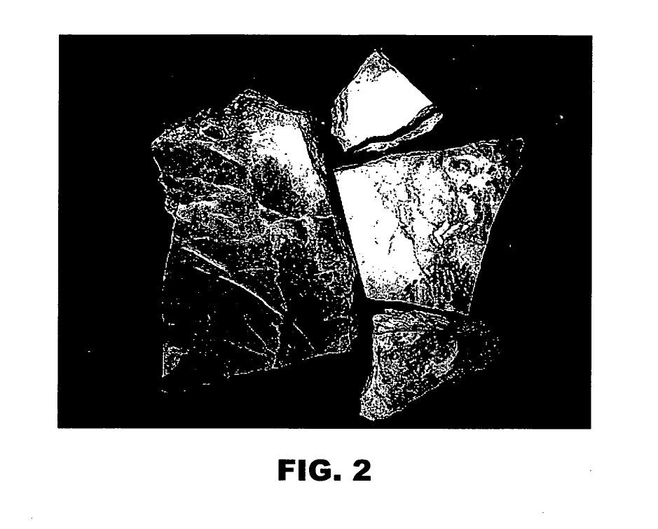

FIG. 2 shows the polished surfaces of the treated chips (lighter color) and the control (larger, darker piece).

### Example 4

### Removal of Organics from Opal-C and Hydrated Amorphous Silica

A rice hull ash sample was supplied by Agrilectric Research Inc., Lake Charles, La., This material had a particle size distribution of d 10 (36 microns); d 50 (110 microns) and d 90 (165 microns). Using NIOSH 7501 x-ray diffraction method for the determination of crystalline silica content, the composition of the starting material was determined to be 7.6% opal-C, a dehydrated form of amorphous biogenic silica, and 92.4% other amorphous material, principally hydrated amorphous biogenic silica and amorphous carbon. No cristobalite or graphite were detected.

301 grams of the sample material was placed in a fused silica tray and preheated at 470 F for 15 minutes in a convection oven. The sample was then exposed to microwave energy in a 1300 watt, 2450 MHz, variable power oven (Panasonic NN-T664SF) for 361 minutes at levels ranging from approximately 910 watts to 1300 watts.

The sample was exposed to a maximum microwave energy of 4319 Kilowatts per metric ton and to cumulative microwave energy of 10,567 Kilowatt hours per metric ton.

This material was removed from the oven and was allowed to cool. This material was a mixture of white and charcoal gray colored particles and was much lighter in color than the starting sample, indicating that a significant amount of carbon had been removed.

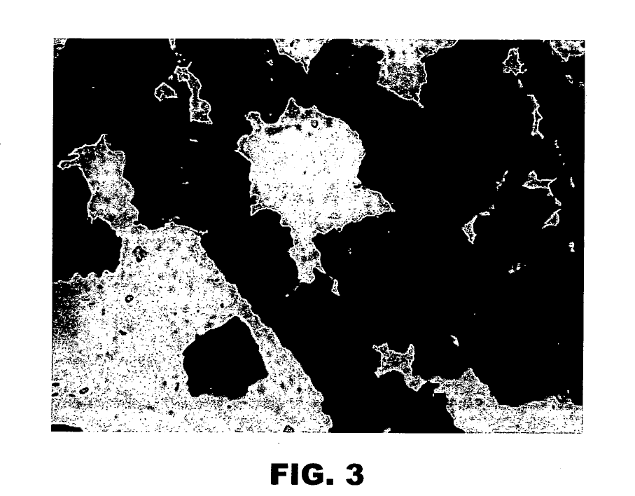

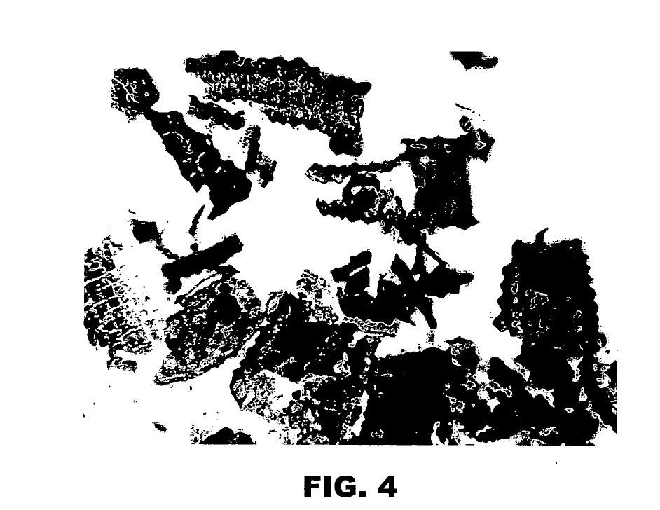

FIGS. 3 and 4 show digital photographs of particles of the sample before and after processing. As the figures show, the processed material is much lighter in color and retains the intricate structure of rice hull ash. The cell structure of the material is intact and there is no visual evidence of melting or the formation of cristobalite.

Using the NIOSH 7501 method, it was determined that this material contains 50.31% opal-C and 49.69% hydrated amorphous biogenic silica and amorphous carbon. No cristobalite or graphite were detected. In other words, none of the hydrated amorphous biogenic silica and zero percent of the opal-C contained in the sample underwent a mineral phase change to cristobalite or other forms of crystalline silica.

### Example 5

### Removal of Organics from Opal-C and Hydrated Amorphous Silica

100 grams of rice hull ash of the same composition and source as in Example 4 were placed in a fused silica tray and were exposed to microwave energy in a 1300 watt, 2450 MHz variable power oven (Panasonic NN-T664SF) for 17.8 hours at levels ranging from approximately 260 watts to 1300 watts.

The sample was exposed to a maximum microwave energy of 13,000 Kilowatts per metric ton and to a cumulative energy of 105,774 Kilowatt hours per metric ton.

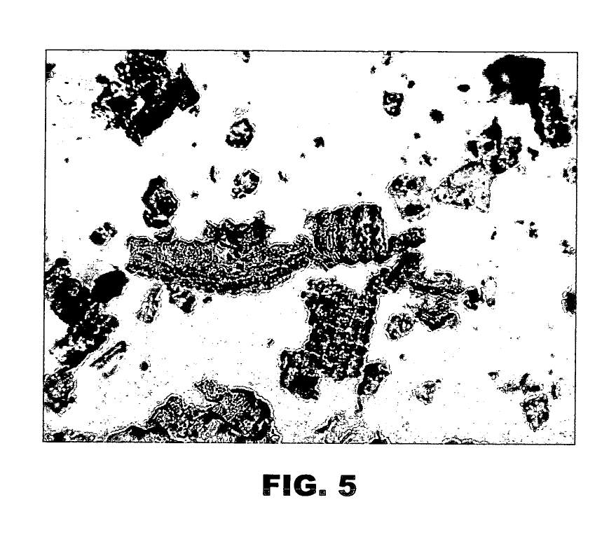

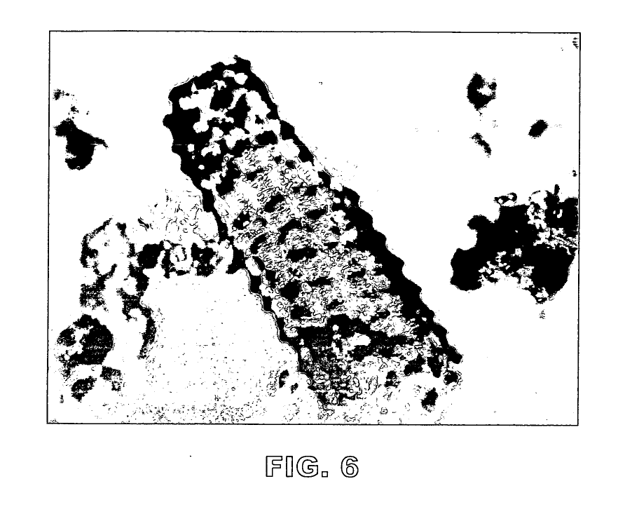

The material was removed and was allowed to cool. As in Example 4, the product was a mixture of white and gray particles, but had a higher percentage of white particles and visually is much lighter in color. FIGS. 5 and 6 show digital photographs of the product, which retains the intricate cellular structure of rice hulls and no evidence of melting or of the formation of cristobalite.

Using the NIOSH 7501 method, it was determined that this material contains 68.32% opal-C and 41.68% hydrated amorphous biogenic silica and amorphous carbon. No cristobalite or graphite were detected. In other words, none of the hydrated amorphous silica and zero percent of the opal-C contained in the sample underwent a mineral phase change to cristobalite or other forms of crystalline silica.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. It should further be noted that any patents, applications and publications referred to herein are incorporated by reference in their entirety.

What is claimed is:

1. A method for removing organic-related compounds from a natural or synthetic material or composition containing at least one permeable inorganic material capable of mineral or mineral phase change or dehydration and at least one amorphous carbon, graphite or another organic compound, comprising:
a. placing said target material in a chamber capable of dielectric heating;
b. subjecting said target material of dielectric energy;
c. obtaining a product containing reduced levels of organic-related materials and an inorganic component in which the mineral and mineral phase are substantially unchanged from the target material except for dehydration when the target material contains a hydrated inorganic component.

2. The method of claim 1, further comprising a step a1. prior to said step a., comprising preheating said target material prior to placing said target material in said chamber.

3. The method of claim 1, wherein said target material is subjected to less than 105,774 kilowatt hours of dielectric energy per metric ton.

4. The method of claim 1, wherein said target material is subjected to between about 1 and about 100,000 kilowatt hours of dielectric energy per metric ton.

5. The methods of claim 1, wherein said target material is subjected to less than 13,000 Kilowatts per metric ton.

6. The method of claim 1, wherein said target material contains a silicate mineral.

7. The method of claim 1, wherein said target material contains amorphous silica or hydrated amorphous silica.

8. The method of claim 1, wherein said target material contains diatomaceous earth, calcined diatomaceous earth, flux calcined diatomaceous earth or spent cake containing a form of diatomaceous earth.

9. The method of claim 1, wherein said target material contains rice hulls or rice hull ash.

10. The method of claim 1, wherein said target material contains biogenic silica, precipitated silica, fumed silica, silica gel or colloidal silica or spent cake containing one or more of these materials.

11. The method of claim 1, wherein said target material contains kaolin clay, ball clay, montmorillonite clay, halloysite, dickite, hectorite, acid activated clay or other clay minerals or spent cake containing acid activated clay.

12. The method of claim 1, wherein said target material contains a calcium silicate mineral, such as wollastonite, tobermorite, palygorskite or other calcium silicate minerals.

13. The method of claim 1, wherein said target material contains talc, pyrophyllite, muscovite mica, biotite mica, sericite mica or phlogopite mica.

14. The method of claim 1, wherein said target material contains a zeolite.

15. The method of claim 1, wherein less than 25% of the target material converts to cristobalite, metakaolin, calcined kaolin, mullite or to another crystalline mineral or crystalline mineral phase (other than opal-c or other amorphous products of dehydration).

16. The method of claim 1, wherein less than 10% of the target material converts to cristobalite, metakaolin, calcined kaolin, mullite or to another crystalline mineral or crystalline mineral phase (other than opal-c or other amorphous products of dehydration).

17. The method of claim 1, wherein less than 1% of the target material converts to cristobalite, metakaolin, calcined kaolin, mullite or to another crystalline mineral or crystalline mineral phase (other than opal-c or other amorphous products of dehydration).

18. The method of claim 1, wherein less than 0.1% of the target material converts to cristobalite, metakaolin, calcined kaolin, mullite or to another crystalline mineral or crystalline mineral phase (other than opal-c or other amorphous products of dehydration).

19. The method of claim 1, wherein the target material contains a material selected from the group consisting of a carbonate mineral, calcite, aragonite, dolomite, magnesite, rhodochrosite, siderite, strontianite, and witherite.

20. The method of claim 1, wherein said target material is selected from the group consisting of limestone, dolomite, dolomitic limestone, magnesite, marble, dolomitic marble, travertine, onyx and caliche.

21. The method of claim 1, wherein said target material contains calcite or aragonite derived from coral, shells or partially metamorphosized coral or shells.

22. The method of claim 1, wherein carbon dioxide is liberated from less than 25% of the target material.

23. The method of claim 1, wherein carbon dioxide is liberated from less than 10% of the target material.

24. The method of claim 1, wherein carbon dioxide is liberated from less than 1% or the target material.

25. The method of claim 1, wherein carbon dioxide is liberated from less than 0.1% of the target material.

26. A product produced by a process, comprising:
a. placing a target material in a chamber capable of dielectric heating;
b. subjecting said target material to dielectric energy; and,
c. obtaining a product containing reduced levels of organic-related materials and an inorganic component in which the mineral and mineral phase are substantially unchanged from the target material except for dehydration when the target material contains a hydrated inorganic component.
